(19) United States
(12) Patent Application Publication
(10) Pub. No.: US 2011/0261678 A1
(43) Pub. Date: Oct. 27, 2011

(54) Establishing a Call Between A First User And A Second User

(76) Inventors: Bettina Sutter, London (GB); Torsten Rehberg, London (GB)

(21) Appl. No.: 12/784,894

(22) Filed: May 21, 2010

(30) Foreign Application Priority Data
Apr. 22, 2010 (GB) 1006726.2

(51) Int. Cl. H04J 1/16

(52) U.S. Cl. 370/216

(57) ABSTRACT

Method, device and computer program product for establishing a call between a first user and a second user, where the first and second users are associated with respective first and second devices which are configured to execute respective first and second communication clients for communicating over a first network. The first communication client attempts to establish a call to the second communication client over the first network using a first identifier associated with the second user in the first network. The first communication client determines that the attempt has failed, and in response displays actuatable secondary call means to the first user on the first device for calling a second identifier associated with the second user in a second network, where the second network is distinct from the first network. In response to the first user actuating the secondary call means, the first communication client establishes a call from the first device over the second network to the second identifier associated with the second user.

### FIELD OF THE INVENTION

This invention relates to establishing a call between a first user and a second user. In particular, the invention relates to establishing such a call over a network.

### BACKGROUND

Packet-based communication systems allow the user of a device, such as a personal computer, to communicate across a computer network such as the Internet. Packet-based communication systems include voice over Internet protocol (“VoIP”) communication systems which can support calls between users of the communication systems. These systems are beneficial to the user as they are often of significantly lower cost than fixed line or mobile networks. This may particularly be the case for long-distance communication. To use a VoIP system, the user must install and execute client software on their device. The client software provides the VoIP connections as well as other functions such as registration and authentication. In addition to voice communication, the client may also provide further features such as video calling, multimedia calling, instant messaging (“IM”), voicemail and file transfer.

A user of a packet-based communication system can establish calls with other users who are simultaneously logged in to the communication system. The client software can be used to store the details of various users, or “contacts”, in the system with whom the user may want to initiate a call. A first user can attempt to establish a call with another user in the system by, for example, selecting the other user's name from a list of contacts and then clicking on a “call” button. Since the client has stored the details of the other user, the client can attempt to establish a call with the other user through the communication system, for example by sending a call request to the other user.

Sometimes the attempt to establish a call with another user through the packet based communication system will fail. This may be, for example, because the other user is offline, or because the other user does not answer the request to establish a call. In these cases the call is not established through the packet based communication system, and the first user's desire to establish a call with the other user is not satisfied. An aim of the present invention is to facilitate the first user's establishment of a call with another user.

### SUMMARY

According to a first aspect of the present invention there is provided a method of establishing a call between a first user and a second user, the first and second users being associated with respective first and second devices which are configured to execute respective first and second communication clients for communicating over a first network, the method comprising: the first communication client attempting to establish a call from the first communication client to the second communication client over the first network using a first identifier associated with the second user in the first network; the first communication client determining that the attempt has failed; in response to determining that the attempt has failed, the first communication client displaying actuatable secondary call means to the first user on the first device for calling a second identifier associated with the second user in a second network, the second network being distinct from the first network; and in response to the first user actuating the secondary call means, the first communication client establishing a call from the first device over the second network to the second identifier associated with the second user.

According to a second aspect of the present invention there is provided a first device, usable by a first user, the first device being part of a first network, the first device comprising a first communication client for communicating, over the first network, with a second communication client at a second device usable by a second user, the first communication client being configured to: attempt to establish a call from the first communication client to the second communication client over the first network using a first identifier associated with the second user in the first network; determine that the attempt has failed; in response to determining that the attempt has failed, display actuatable secondary call means to the first user on the first device for calling a second identifier associated with the second user in a second network, the second network being distinct from the first network; and in response to the first user actuating the secondary call means, establish a call from the first device over the second network to the second identifier associated with the second user.

According to a third aspect of the present invention there is provided a computer program product comprising computer readable instructions for execution by computer processing means at a first device for establishing a call between a first user of the first device and a second user of a second device, the first and second devices being configured to execute respective first and second communication clients for communicating over a first network, the instructions comprising instructions for: the first communication client attempting to establish a call from the first communication client to the second communication client over the first network using a first identifier associated with the second user in the first network; the first communication client determining that the attempt has failed; in response to determining that the attempt has failed, the first communication client displaying actuatable secondary call means to the first user on the first device for calling a second identifier associated with the second user in a second network, the second network being distinct from the first network; and in response to the first user actuating the secondary call means, the first communication client establishing a call from the first device over the second network to the second identifier associated with the second user.

Preferably the second network is a Public Switched Telephone Network (PSTN), and the second identifier is a number associated with the second user in the PSTN. Preferably the first network is a packet switched network, for example a peer to peer (P2P) communications network.

When the first user is unable to establish a call through the first network, the secondary call means are displayed to the first user. The first user can actuate the secondary call means to establish a call with the second user over the second network. In this way, where the first network is a P2P network and the second network is the PSTN, means to initiate a call to a PSTN number associated with the second user are selectively provided to the first user in dependence on the availability of the second user in the P2P network.

As an example, if the second user is offline in the first network and the first user fails in an attempt to establish a call with the second user over the first network then a call button for initiating a call to the second user's PSTN number is displayed when the user attempts to call the offline contact. Alternatively, when the second user is offline in the first network and the first user attempts to establish a call with the second user over the first network, the attempted call may be passed to voicemail for the second user. The first user can then leave a message for the second user on his voicemail, and the attempted call would not be considered to have failed.

As another example, if a call to the second device over the first network is unanswered by the second user within a predetermined time then a call button for initiating a call to an identity associated with the second user in the second network (e.g. the second user's PSTN number) is displayed.

Communication over the first network is achieved by executing respective communication clients at the first and second devices. It is the communication client at the first device that attempts to establish a call to the second device over the first network and when that attempt fails (for one of many possible reasons) it is the communication client at the first device that displays the secondary call means to the first user for calling an address associated with the second user in the second network. Therefore the first device has the ability to perform the methods described herein without being reliant on central servers of the first network. Therefore the first device can be used in different networks and the networks themselves do not require any adaptation for the methods described herein to be performed by the first device.

A condition for displaying the secondary call means may be that the first user has credit in the first network. A further condition for displaying the secondary call means may be that at least one PSTN number is associated with the second user.

In prior systems, a communication client for use in communicating over the first network may store PSTN numbers of other users in the first network. A user may look up the PSTN number of another user and then place a call to the other user's PSTN number. This may involve navigating through various menus and options to find the PSTN number which may prove troublesome for the user, particularly when the device is a portable device such as a mobile phone in which the user interface can be difficult to manipulate quickly. In contrast, in the systems described herein the first user is not required to look up alternative contact details for the second user, and instead when the first user is unable to establish a call with the second user over the first network the first communication client displays the secondary call means which the first user can simply actuate to thereby establish a call with the second user over the second network. The systems described herein are therefore easier and quicker to use than the prior systems described above.

Furthermore, the secondary call means (e.g. a call button) is only displayed when required, which is particularly advantageous for portable devices (e.g. mobile platforms) where the screen size is limited. Before the attempt to establish a call from the first communication client to the second communication client over the first network has failed, the secondary call means is preferably not displayed on the first device.

### BRIEF DESCRIPTION OF THE DRAWINGS

For a better understanding of the present invention and to show how the same may be put into effect, reference will now be made, by way of example, to the following drawings in which:

FIG. 1 is a schematic diagram of a communication system according to a preferred embodiment;

FIG. 2 shows a first user interface for display on a device;

FIG. 3 is a schematic diagram of a device according to a preferred embodiment;

FIG. 4 shows a flowchart of a process for establishing a call according to a preferred embodiment; and

FIG. 5 shows a second user interface for display on a device.

### DETAILED DESCRIPTION OF PREFERRED EMBODIMENTS

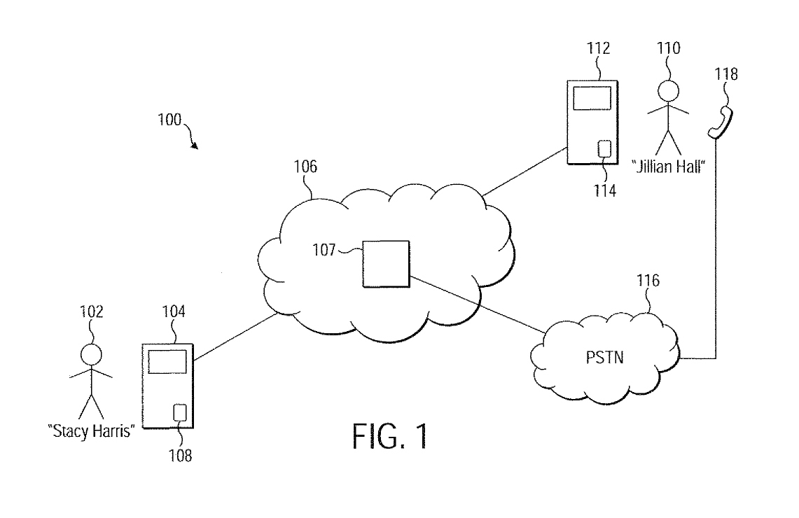

Reference is first made to FIG. 1, which illustrates a communication system 100. Note that whilst this illustrative embodiment is described with reference to a P2P communication system, other types of communication system could also be used, such as non-P2P, VoIP or IM systems. A first user of the communication system (named “Stacy Harris” 102) operates a first user device 104, which is shown connected to a first network 106. The first network 106 may be for example the Internet. The first user device 104 may be, for example, a mobile phone, a personal digital assistant (“PDA”), a personal computer (“PC”) (including, for example, Windows™, Mac OS™ and Linux™ PCs), a gaming device or other embedded device able to connect to the first network 106. The first user device 104 is arranged to receive information from and output information to the first user 102 of the device. In a preferred embodiment of the invention the first device 104 comprises a display such as a screen and an input device such as a keypad, joystick, touch-screen, keyboard and/or mouse. The first device 104 is connected to the network 106.

Note that in alternative embodiments, the first device 104 can connect to the communication network 106 via additional intermediate networks not shown in FIG. 1. For example, if the first device 104 is a mobile device, then it can connect to the communication network 106 via a cellular mobile network (not shown).

The first device 104 is configured to execute a first communication client 108, provided by a software provider. The first communication client 108 is a software program executed on a local processor in the first device 104.

FIG. 1 also shows a second user 110 (“Jillian Hall”). The second user 110 is a user of a second device 112 which is configured to execute a second communication client 114. The second device 112 and second communication client 114 are similar in operation to first device 104 and the first communication client 108. The second device 112 is connected to the first network 106, such that the first and second users (102 and 110) can communicate with each other over the first network 106 using the first and second communication clients (108 and 114) executed at the first and second devices (104 and 112).

Also shown in FIG. 1 is a second network 116 (e.g. a PSTN network 116) connected to the first network 106. The second user 110 is associated with a device 118 in the second network 116. In the example shown in FIG. 1, the second user 110 is associated with a telephone 118 in the PSTN network 116. The telephone 118 is identified in the PSTN network 116 by a PSTN number, as is known in the art.

As shown in FIG. 1, the first network 106 comprises a gateway node 107 which can be used to route communications from the first network 106 to the second network 116.

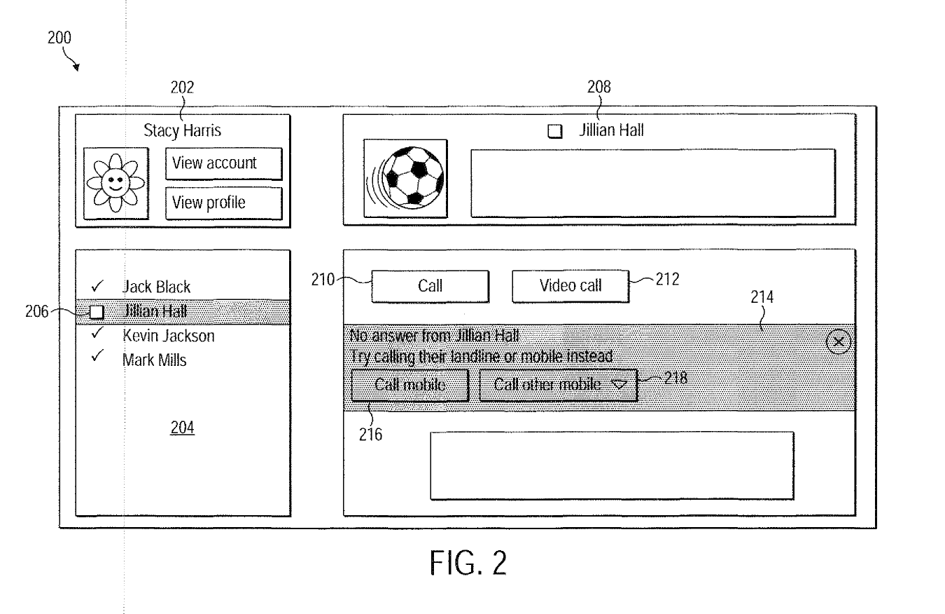

An example of a user interface 200 of the communication client 108 executed on the first device 104 is shown illustrated in FIG. 2. The user interface 200 can be different depending on the type of device 104. For example, the user interface 200 can be smaller or display information differently on a mobile device, due to the small screen size. In the example of FIG. 2, the client user interface 200 displays the username 202 of “Stacy Harris” 102 in the communication system.

The client user interface 200 comprises a pane 204 which displays a contact list of the contacts stored by the user 102. In the example user interface 200, four contacts of other users of the communication system are shown listed in contact list 204. Each of these contacts have authorised the user 102 of the client 108 to view their contact details and presence state. Each contact in the contact list has a presence status icon associated with it. For example, the presence status icon 206 for “Jillian Hall” 110 indicates that this contact is “offline”, and the presence icons for “Jack Black”, “Kevin Jackson” and Mark Mills” indicate that these contacts are “online”.

The contacts in the contact list for a user (e.g. “Stacy Harris”) are stored in a contact server (not shown in FIG. 1). When the client 108 first logs into the communication system the contact server is contacted, and the contacts in the contact list are downloaded to the first device 104. This allows the user 102 to log into the communication system from any terminal and still access the same contact list.

VoIP calls to the users in the contact list may be initiated over the communication system by selecting the contact and clicking on a “call” button 210 using a pointing device such as a joystick or a mouse. For example, as shown in FIG. 2 the first user 102 (“Stacy Harris”) can select the second user 110 (“Jillian Hall”), and as shown in FIG. 2 details of the second user 208 are displayed in the user interface 200. Options for interacting with the second user 110 are displayed to the first user, such as the call button 210 for initiating a call with the second user 110 and a video call button 212 for initiating a video call with the second user 110. Alternatively, a multimedia call could be established between the first and second users. Referring again to FIG. 1, a call can be attempted to be established using proprietary protocols, and the route over the network 106 between the calling user (e.g. user 102) and called user (e.g. user 110) is determined by the peer-to-peer system without the use of central servers, as is known in the art. For example, the first user “Stacy Harris” 102 can attempt to call a second user “Jillian Hall” 110 over the first network 106.

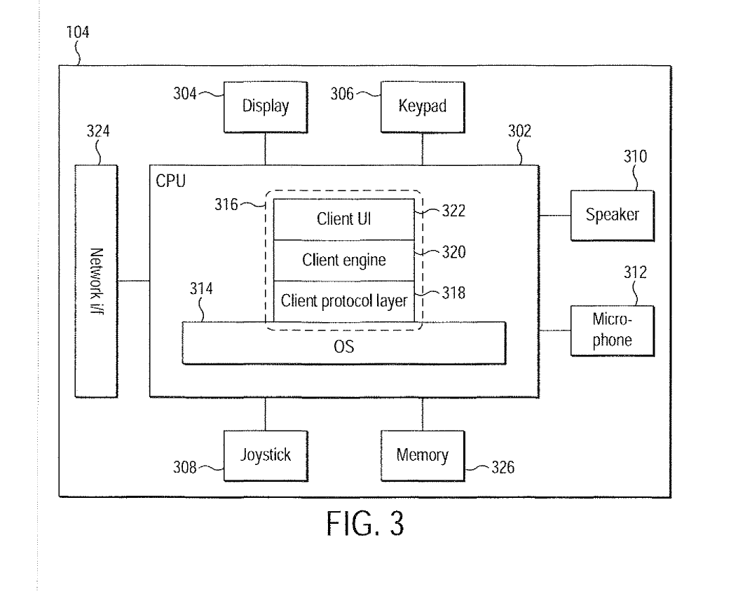

FIG. 3 illustrates a detailed view of the first device 104 on which is executed client 108. The first device 104 comprises a central processing unit (“CPU”) 302, to which is connected a display 304 such as a screen, input devices such as a keypad (or a keyboard) 306 and a pointing device such as a joystick 308. The display 304 may comprise a touch screen for inputting data to the CPU 302. An output audio device 310 (e.g. a speaker) and an input audio device 312 (e.g. a microphone) are connected to the CPU 302. The display 304, keypad 306, joystick 308, output audio device 310 and input audio device 312 are integrated into the first device 104. In alternative devices one or more of the display 304, the keypad 306, the joystick 308, the output audio device 310 and the input audio device 312 may not be integrated into the device and may be connected to the CPU 302 via respective interfaces. One example of such an interface is a USB interface. A pointing device such as a mouse (not shown) may be connected to the CPU 302 via an interface (not shown). The CPU 302 is connected to a network interface 326 such as a modem for communication with the first network 106. The network interface 326 may be integrated into the first device 104 as shown in FIG. 3. In alternative devices the network interface 326 is not integrated into the device. The first device 104 comprises a memory 326 for storing data. The memory 326 is configured such that data can be transferred between the CPU 302 and the memory 326 as is known in the art.

FIG. 3 also illustrates an operating system (“OS”) 314 executed on the CPU 302. Running on top of the OS 314 is a software stack 316 for the client 108. The software stack shows a client protocol layer 318, a client engine layer 320 and a client user interface layer (“UI”) 322. Each layer is responsible for specific functions. Because each layer usually communicates with two other layers, they are regarded as being arranged in a stack as shown in FIG. 3.

The operating system 314 manages the hardware resources of the computer and handles data being transmitted to and from the network via the network interface 326. The client protocol layer 318 of the client software communicates with the operating system 314 and manages the connections over the communication system. Processes requiring higher level processing are passed to the client engine layer 320. The client engine 320 also communicates with the client user interface layer 322. The client engine 320 may be arranged to control the client user interface layer 322 to present information to the user via the user interface of the client (as shown in FIG. 2) and to receive information from the user via the user interface.

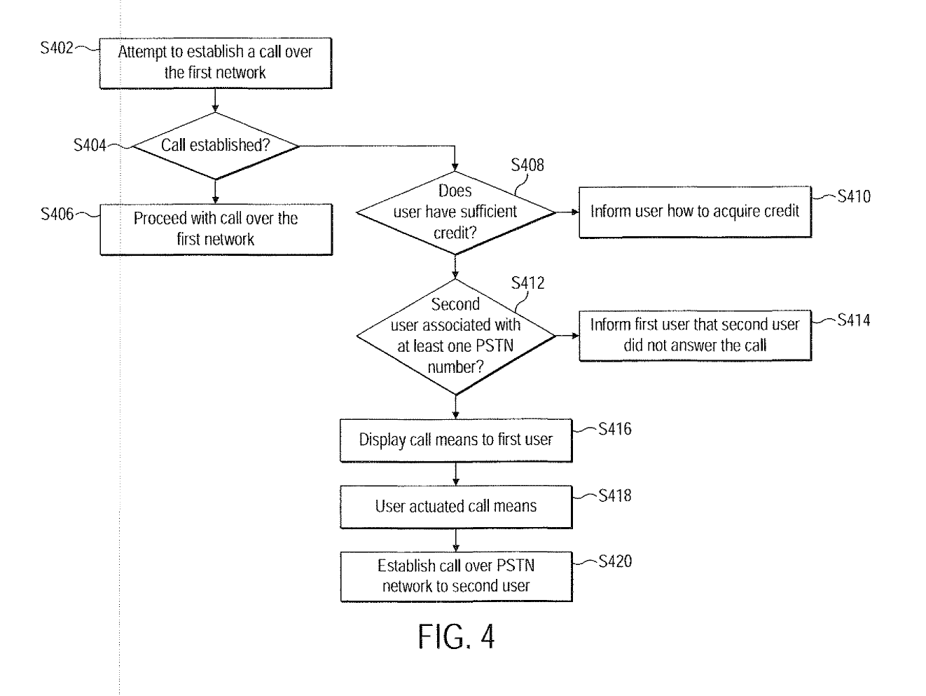

With reference to FIG. 4 there is now described a method of establishing a call according to a preferred embodiment. In step S402 the first user 102 clicks on the call button 210 shown in FIG. 2 and in response the first communication client 108 attempts to establish a call with the second communication client 114 over the first network 106. In order to attempt to establish the call to the second communication client 114, the first communication client 108 sends an identifier of the second communication client 114 with a request to establish the call to the first network 106. The identifier identifies the second communication client 114 and in this sense the identifier is associated with the second user 110 since it identifies a communication client to which communications can be sent in order to communicate with the second user 110. The first communication client 108 determines that the identifier identifies a communication client in the first network 106 and that a call can be established to the second communication client 114 through the first network 106. The call request is routed to the second communication client 114 through the first network 106.

If the second user 110 accepts the call over the first network 106 then the call is established and the first and second users can communicate over the first network 106. However, the second user 110 might not accept the call over the first network 106, in which case the call over the first network 106 is not established. For example, if the second user 110 is offline in the first network 106 then the call might not be able to be established over the first network 106. As another example, the second user 110 might not answer the call over the first network 106 if for example the second user 110 is not aware of the attempt to establish the call or chooses not to answer the call.

In step S404 the first communication client 108 determines whether the call can be established over the first network 106 to the second user 110. If the call can be established over the first network 106 then in step S406 the call proceeds between the first communication client 108 and the second communication client 114 over the first network 106.

If in step S404 it is determined that the call cannot be established over the first network 106 then the method passes to step S408. In step S408 it is determined whether the first user 102 has sufficient credit in the first network to establish a call over the second network 116 with the second user 110. For the first user 102 to establish a call with the second user 110 over the second network 116 the first communication client 108 determines that the call is to an identifier in the second network 116 and the call is routed to the gateway node 107 in the first network 106. The call is then routed to the second network 116 from the gateway node 107. In the example embodiments in which the second network is the PSTN 116, the gateway node 107 may select one from a plurality of further PSTN gateway nodes (not shown) to route the call to (e.g. depending on the country in which the device 118 is located). It may incur a cost to route a call to the second network 116, for example if the second network 116 is a PSTN network 116. Therefore, in order for the first user 102 to establish a call over the second network 116 he may be required to have a sufficient level of credit in the first network 106.

If it is determined in step S408 that the first user 102 does not have sufficient credit then the method passes to step S410 in which the user is informed of how to acquire credit such that the first user could establish a call over the second network 116. This may be implemented by a banner appearing on the user interface (not shown in the Figures) informing the first user 102 that he has insufficient credit to establish a call over the second network 116 and may include instructions for the first user 102 as to how to obtain credit.

If it is determined in step S408 that the first user 102 does have sufficient credit to establish a call over the second network 116 then the method passes to step S412 in which it is determined whether the second user is associated with at least one identifier in the second network 116 (e.g. a PSTN number where the second network is the PSTN network 116). The determination in step S412 can be implemented by querying a central server of the first network 106 which stores details of the second user 110. As part of the details of the second user 110, PSTN numbers or other identifiers associated with the second user 110 in other networks may be stored. A PSTN number stored for the second user 110 may identify the device 118 associated with the second user 110 which will ring when the PSTN number is called over the PSTN network 116. The device 118 is shown in FIG. 1 as a separate device to the second device 112 in which the second communication client 114 is executed for communicating over the first network 106. However, in alternative embodiments, the device 118 may be incorporated into the same device as the device in which the second communication client 114 is executed for communicating over the first network 114. For example, a mobile phone may be identified by the PSTN number associated with the second user 110, and that same mobile phone may implement the second communication client 114 for communicating over the first network 106.

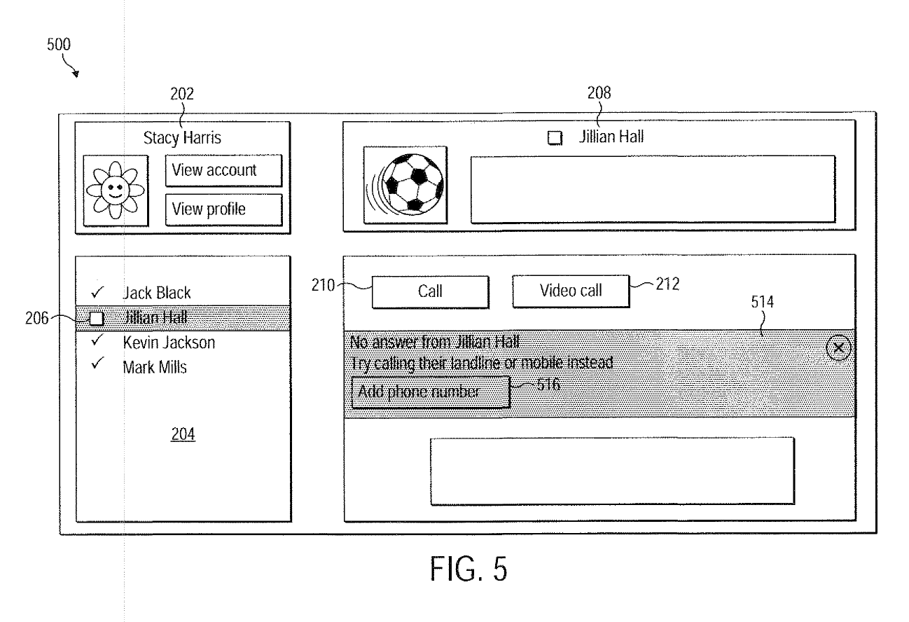

If in step S412 it is determined that the second user is not associated with at least one identifier (e.g. PSTN number) in the second network 116 (e.g. PSTN network 116) then the method passes to step S414 in which the first user 102 is informed that the second user 110 did not answer the call that was attempted to be established in step S402. This may be implemented by a banner appearing on the user interface (not shown in the Figures) informing the first user 102 that the call with the second user could not be established over the first network 106. It is noted that any time the attempt to establish a call in step S402 fails the first user 102 will be informed of the failure. This can be independent of whether the first user 102 has credit or not in the first network 106. This can also be independent of whether the second user 110 is associated with at least one identifier in the second network 116. As well as informing the first user 102 that the attempt to establish a call has failed the first user 102 can be asked to enter an identifier (e.g. a PSTN number) for the second user 110 in the second network 116, as described later with reference to FIG. 5.

If it is determined in step S412 that the second user is associated with at least one identifier (e.g. PSTN number) in the second network 116 (e.g. PSTN network 116) then the method passes to step S416 in which the first communication client 108 displays secondary call means to the first user 102 on the user interface 200. As shown in FIG. 2 a banner 214 is displayed when the call cannot be established over the first network 106. The banner 214 includes a “call” button 216 and a “call other number” menu 218. The call button 216 is an example of the secondary call means that could be displayed to the first user 102. As shown in FIG. 2 the banner 214 also informs the first user 102 that there is no answer from the second user 110 (“Jillian Hall”) and suggests to the first user 102 that they try calling their landline or mobile instead.

The banner 214 uses space on the user interface 200. Considering the space on the user interface 200 is particularly important when the screen of the device 104 is small, for example when the device 104 is a portable device such as a mobile phone. The first user 102 can close the banner 214 by clicking on the cross at the top right of the banner, thereby freeing up the space in the user interface 200. In some embodiments, the banner 214 is displayed to the first user 102 only once per conversation with the second user 110. This avoids unnecessary repetition of informing the user that they could try calling other numbers associated with the second user when the first user 102 has already chosen to close the banner 214 in the same conversation. In other embodiments the banner 214 is displayed to the first user 102 after every failed attempt to establish a call over the first network 106.

In step S418 the first user 102 actuates the secondary call means. For example, in the user interface 200 shown in FIG. 2, the first user 102 can click on the call button 216. Where the second user is associated with more than two numbers in the second network 116 the menu 218 can be selected such that it then displays a list of the different numbers associated with the second user 110. The first user 102 can then select one of the numbers from the list indicating that she wishes to call the selected number through the second network 116.

In step S420 a call from the first device 104 is established to the identifier associated with the second user in the second network 116 in response to the first user 102 actuating the secondary call means (e.g. by clicking the call button 216) in step S418. The first communication client 108 determines that the identifier is an identifier in the second network 116 and sends a call request to the gateway node 107 in the first network 106 including the identifier of the second user 112 in the second network 116. The gateway node 107 will route the call request to the second network 116 (e.g. via further gateway nodes). The call request is then routed to the device 118 identified by the identifier through the second network 116.

In this way the call can be established through the second network 116. The second network is distinct from the first network 106. This means that the call that is established in step S420 uses a distinct network from the network used in the failed attempt to set up a call as determined in step S404. Since the first attempt to set up a call to the second user 110 failed it can be advantageous to use a distinct network to set up the call in step S420 in case the failure of the first attempt was due to reasons associated with the first network 106 or associated with the second device 112 connected to the first network 106 (e.g. the second device 112 may be switched off, whereas the device 118 connected to the distinct second network 116 may be switched on). There are many possible scenarios in which the second user 110 may be more easily contactable via device 118 rather than device 112 as would be apparent to a skilled person, such as when device 112 is not a portable device but device 118 is a portable device.

The first and second networks preferably utilise different communication protocols. This may be advantageous if the failure of the first attempted call was due to reasons associated with the protocol of the first network 106. In the preferred embodiments described in relation to FIG. 1 the first network is a P2P packet switched network and the second network 116 is the PSTN, which use different protocols.

If the second user 110 is offline when the first user 102 attempts to establish the call in step S402 then the call may be passed to the second user's voicemail. In this case in step S404 it would be determined that the call has been established over the first network 106 and the method passes to step S406 in which the first user 102 may leave a message for the second user 110 in his voicemail. In this case the steps S408 to S420 would not be carried out.

It would be apparent to a skilled person that steps S408 to S414 are optional steps, and are not necessarily carried out in some embodiments. For example, in some embodiments, it is not necessary to check that the first user has sufficient credit to establish a call over the second network in step 5408. This may, for example, be because no charges are incurred for establishing a call over the second network 116. Furthermore, instead of explicitly checking that the second user is associated with at least one PSTN number in step S412 it may instead be assumed that the second user is associated with at least one PSTN number. Therefore, the method could pass straight from step S404 to step S416 when it is determined that a call cannot be established over the first network in step S404.

In step S414 when it has been determined in step S412 that the second user 110 is not associated with a PSTN number, the banner 514 shown in FIG. 5 can be displayed to the first user 102. The banner 514 includes a button 516 which can be used to add a phone number associated with the second user 110 to the central store on the first network 106. This allows the first user 102 to enter a PSTN number of the second user 110 which can subsequently be used to establish a call with the second user over the PSTN network 116. When the first user 102 clicks on the button 516 the first user will then be prompted to input the PSTN number of the second user 110. The first user 102 may, or may not, then be asked whether a call should be established with the PSTN number associated with the second user.

Clicking the button 516 or the cross in the top right corner of the banner 514 closes the banner 514 and may, or may not, dismiss this type of message permanently across the client.

There has therefore been provided a method by which the first user 102 can establish a call to the second user 110 over the second network 116 when an attempt to establish a call with the second user 110 over the first network 106 has failed. The methods described above are particularly advantageous because the first user 102 does not have to open up an address book or similar storage means to retrieve an alternative contact address of the second user. Instead, the first user 102 simply has to actuate the secondary call means that is displayed and the first communication client 108 establishes the call over the second network 116.

While this invention has been particularly shown and described with reference to preferred embodiments, it will be understood to those skilled in the art that various changes in form and detail may be made without departing from the scope of the invention as defined by the appendant claims.

1. A method of establishing a call between a first user and a second user, the first and second users being associated with respective first and second devices which are configured to execute respective first and second communication clients for communicating over a first network, the method comprising:
the first communication client attempting to establish a call from the first communication client to the second communication client over the first network using a first identifier associated with the second user in the first network;
the first communication client determining that the attempt has failed;
in response to determining that the attempt has failed, the first communication client displaying actuatable secondary call means to the first user on the first device for calling a second identifier associated with the second user in a second network, the second network being distinct from the first network; and
in response to the first user actuating the secondary call means, the first communication client establishing a call from the first device over the second network to the second identifier associated with the second user.

2. The method of claim 1 wherein the first and second networks utilise different communication protocols.

3. The method of claim 1 wherein the second network is a Public Switched Telephone Network, and the second identifier is a number associated with the second user in the Public Switched Telephone Network.

4. The method of claim 1 wherein the first network is a packet switched network.

5. The method of claim 4 wherein the first network is a peer to peer communications network.

6. The method of claim 1 wherein the step of attempting to establish a call comprises routing a call to the second communication client through the first network using the first identifier.

7. The method of claim 1 wherein the step of establishing a call comprises sending the second identifier from the first communication client to a gateway node in the first network, wherein the gateway node determines how to route a call to the second identifier through the second network.

8. The method of claim 1 wherein if the second user is offline in the first network when the first user attempts to establish a call from the first communication client to the second communication client over the first network then it is determined that the attempt has failed.

9. The method of claim 1 wherein if when the first user attempts to establish a call from the first communication client to the second communication client over the first network the call is unanswered by the second user for a predetermined time then it is determined that the attempt has failed.

10. The method of claim 1 wherein the secondary call means is displayed as a button at the first device and is configured to be actuated when the first user clicks on the button.

11. The method of claim 1 wherein the secondary call means is a list of available second identifiers associated with the second user in the second network, and wherein the secondary call means is configured to be actuated when the first user selects one of the available second identifiers from the list,

12. The method of claim 1 further comprising determining that the first user has sufficient credit to establish the call from the first device over the second network to the second identifier associated with the second user, wherein the step of displaying the actuatable secondary call means is performed only if it is determined that the first user has sufficient credit.

13. The method of claim 1 further comprising determining that the second user is associated with at least one second identifier in the second network, wherein the step of displaying the actuatable secondary call means is performed only if it is determined that the second user is associated with at least one second identifier in the second network.

14. The method of claim 1 wherein the actuatable secondary call means is displayed to the first user only once per conversation with the second user.

15. The method of claim 1 wherein the call is one of an audio call, a video call and a multimedia call.

16. A first device, usable by a first user, the first device being part of a first network, the first device comprising a first communication client for communicating over the first network with a second communication client at a second device usable by a second user, the first communication client being configured to:
attempt to establish a call from the first communication client to the second communication client over the first network using a first identifier associated with the second user in the first network;
determine that the attempt has failed;
in response to determining that the attempt has failed, display actuatable secondary call means to the first user on the first device for calling a second identifier associated with the second user in a second network, the second network being distinct from the first network; and
in response to the first user actuating the secondary call means, establish a call from the first device over the second network to the second identifier associated with the second user.

17. A computer program product embodied on a computer readable medium, comprising computer readable instructions for execution by computer processing means at a first device for establishing a call between a first user of the first device and a second user of a second device, the first and second devices being configured to execute respective first and second communication clients for communicating over a first network, the instructions comprising instructions for:
the first communication client attempting to establish a call from the first communication client to the second communication client over the first network using a first identifier associated with the second user in the first network;
the first communication client determining that the attempt has failed;
in response to determining that the attempt has failed, the first communication client displaying actuatable secondary call means to the first user on the first device for calling a second identifier associated with the second user in a second network, the second network being distinct from the first network; and
in response to the first user actuating the secondary call means, the first communication client establishing a call from the first device over the second network to the second identifier associated with the second user.
